(19) United States
(12) Patent Application Publication
(10) Pub. No.: US 2006/0286371 A1
(43) Pub. Date: Dec. 21, 2006

(54) MRT film filter and plasma display apparatus having the same

(76) Inventors: Ji-Suk Kim, Suwon-si (KR); Sung-Yong Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/433,295

(22) Filed: May 12, 2006

(30) Foreign Application Priority Data
Jun. 15, 2005 (KR) 10-2005-0051359

(51) Int. Cl. B32B 27/36; B32B 27/38; B32B 27/40; B32B 15/04; B32B 27/20

(52) U.S. Cl. 428/336; 428/411.1; 428/412; 428/480; 428/473.5; 428/532; 428/413; 428/423.1; 428/447; 428/457

(57) ABSTRACT

Provided is an MRT film filter that has improved interface characteristics, produces fewer dual images, and has reduced manufacturing costs. The MRT film filter includes: a base filter; an anti-glare layer disposed on top of the base film; a conductive layer that is disposed on one side of the base film and blocks electromagnetic waves; an MRT film disposed below the base film to be adhered to a flat display apparatus; and an adhesive adapted to fix the MRT film to the base film. Also provided is a plasma display device comprising the MRT film filter.

### CROSS-REFERENCE TO RELATED APPLICATIONS

This application claims the priority of Korean Patent Application No. 10-2005-0051359, filed on Jun. 15, 2005, in the Korean Intellectual Property Office, the disclosure of which is incorporated herein in its entirety by reference.

### BACKGROUND OF THE INVENTION

1. Field of the Invention

The present embodiments relate to a microreplication technology (MRT) film filter and a Plasma Display Panel (PDP), and more particularly, to an MRT film filter which is adhered directly to a front substrate of a flat display apparatus to block near infrared and electromagnetic waves and a plasma display apparatus having the same.

2. Description of the Related Art

Strong near infrared waves are emitted in plasma display apparatuses due to the driving characteristics thereof. Such near infrared waves affect operations of, for example, wireless telephones or remote controls and cause malfunctions.

In addition, plasma display apparatuses generate strong electromagnetic waves which affect other electronic appliances.

Therefore, a front surface filter which blocks such near infrared and electromagnetic waves is disposed in plasma display apparatuses. Since the front surface filter is mounted on the front of PDPs, it needs to be transparent to visible light while opaque to near infrared and electromagnetic waves.

Conventional front filters for PDPs having the above-described characteristics can be classified into metal mesh type front filters and transparent conductive type front filters. The mesh type front filter is excellent for blocking electromagnetic waves, but has relatively poor transparency and may cause distortion of an image. Also, since the mesh itself is expensive, the overall cost of the product increases.

Therefore, a transparent conductive-type front filter pass through surface process is typically used. The surface processing technique for a film of a PDP is a technique of processing a front surface of a panel. A good surface process technique will minimize external light reflection and prevent reduction in resolution and static electricity.

In a conventional plasma display apparatus, refraction occurs between a front substrate, which is commonly glass, and the front glass filter since the two media have different refractive indices. This causes an image to be reflected twice.

Also, the front filter has a predetermined thickness in order to sustain external impact. Therefore, the weight and cost of the plasma display apparatus are increased. In addition, the conventional strengthened glass filter has a very complex structure in which films performing various functions are included. Therefore, the manufacturing cost of the plasma display apparatus is increased.

### SUMMARY OF THE INVENTION

The present embodiments provide a microreplication technology (MRT) film filter for a Plasma Display Panel (PDP) in which a thin film can perform the functions of a strengthened glass filter film, and a plasma display apparatus having the MRT film filter.

The present embodiments also provide an MRT film filter and a plasma display apparatus having the same, the MRT film filter having improved interface characteristics to prevent dual images produced by an interface, reduced surface reflection, and improved true contrast.

According to an aspect of the present embodiments, there is provided an MRT film filter including a base filter; an anti-glare layer disposed on top of the base film; a conductive layer that is disposed on one side of the base film and blocks electromagnetic waves; an MRT film disposed below the base film to be adhered to a flat display apparatus; and an adhesive disposed below the base film to fix the MRT film to the base film.

The base film may be transparent.

The anti-glare layer may contain a hard coating material and can have a thickness of from about 2 to about 7 μm, a hardness of from about 2 to about 3H, and a haze of from about 3 to about 11%.

The conductive layer may be made of at least one of ITO, Ag, Au, Cu, and Al.

The adhesive may contain a pigment or a dye for color correction or blocking neon light.

The MRT film filter may further include a black coating on top of the MRT film to improve true contrast; and a lens unit below the MRT film to focus visible light.

According to another aspect of the present embodiments, there is provided a plasma display apparatus including the MRT film filter described above.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a perspective view of a microreplication technology (MRT) film filter according to one embodiment;

FIG. 2 is a cross-sectional view of the MRT film filter in FIG. 1 taken along line V-V;

FIG. 3 is a cross-sectional view of an MRT film filter according to another embodiment;

FIG. 4 is a cross-sectional view of an MRT film filter according to another embodiment; and

FIG. 5 is a perspective view of a plasma display apparatus having an MRT film filter according to another embodiment.

### DETAILED DESCRIPTION OF THE INVENTION

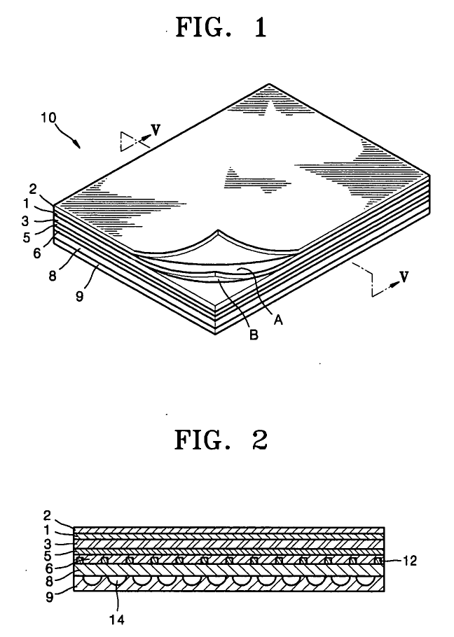

FIG. 1 is a perspective view of a microreplication technology (MRT) film filter 10 according to one embodiment. In FIG. 1, layers of the multi-layered MRT film filter are partially turned up so that the MRT film filter is clearly shown. FIG. 2 is a cross-sectional view of a portion of the MRT film filter 10 in FIG. 1 taken along line V-V.

Referring to FIGS. 1 and 2, the MRT film filter 10 includes a base film 3, an anti-glare layer 1, a hard coating material 2 preventing scratching, a conductive layer 5, an MRT film 8, which is a film made using a microreplication technique, and an adhesive 6 which fixes the base film 3 to the MRT film 8. The MRT film filter 10 may further include a supporter 9 which fixes the MRT film 8 to a flat display apparatus.

The flat display apparatus is a device which emits visible rays so that a viewer can see an image, and may be a device having a flat front surface through which the visible rays are emitted. Examples of the flat display apparatus include a Plasma Display Panel (PDP), a Field-Effect Display (FED), a Vacuum Fluorescent Display (VFD), an Organic Light Emitting Diode (OLED), and a Liquid Crystal Display (LCD). In a PDP, a gas discharge occurs between two electrodes when a strong voltage is applied to the electrodes, UV rays are generated, and the UV rays collide with a phosphor material, generating visible light. In an FED, electrons emitted from a flat cathode (an electron emitting source) collide with a phosphor material to emit light. In a VFD, a voltage is applied to a filament to generate thermions; the thermions are accelerated in a grid and collide with a patterned phosphor material formed on an anode, generating visible light. In an OLED, when a current is supplied to a phosphor or phosphorescent organic thin film, electrons couple with holes in an organic layer, thereby emitting light. An LCD is a display in which electrical characteristics of liquid crystals, which are in an intermediate state between a liquid and solid, are adopted in a display apparatus. The liquid crystals act as a shutter and transmitsor block visible rays depending on the on/off state of a voltage to display information on the LCD. However, the present embodiments are not limited to the displays described above.

The base film 3 is a frame of the MRT film filter. The material of the base film 3 is selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, policarbonate (PC), and cellulose acetate propionate (CAP). In one embodiment, the material may be PC, PET, tri acetyl celluloase (TAC), or PEN.

The base film 3 may be transparent. Here, transparent means having a transmittance rate which can be commonly referred to as being transparent by one of ordinary skill in the art.

The conductive layer 5 is disposed on the bottom of the base film 3. The conductive layer 5 blocks electromagnetic and near infrared waves harmful to humans which are emitted from the plasma display apparatus. In particular, the near infrared waves are blocked to prevent the malfunction of peripheral electronic appliances.

In FIGS. 1 and 2, the conductive layer 5 is a single layer, but it can have a multi-layered structure, in which two or more layers are stacked. If the conductive layer 5 has a multi-layered structure, the resistance of the surface of the conductive layer 5 can be changed, and thus the transmittance of visible rays can be controlled.

The conductive layer 5 may be made of, for example, metal, a metal oxide, or a conductive polymer. Examples of the metal include palladium, copper, platinum, rhodium, aluminum, iron, cobalt, nickel, zinc, ruthenium, tin, tungsten, iridium, lead, and Ag and compounds thereof.

The metal oxide may include at least one of tin oxide, indium oxide, antimony oxide, zinc oxide, zirconium oxide, titan oxide, magnesium oxide, silicon oxide, aluminum oxide, metal alkoxide, indium tin oxide (ITO), and antimony tin oxide (ATO). Also, the conductive layer 5 may be composed of a combination of the metal and the metal oxide. If a metal oxide is included, oxidation or deterioration of the metal layer 5 can be prevented.

The metal layer 5 may have a structure in which ITO and Ag are alternately stacked at least twice.

The metal layer 5 can be formed in numerous ways, for example, by sputtering, vacuum deposition, ion plating, Chemical Vapor Deposition (CVD), Physical Vapor Deposition (PVD), metal particle coating or metal oxide particle coating.

A compound which absorbs near infrared waves may be additionally included in the adhesive 6, which will be described later, to block near infrared waves together with the conductive layer 5.

For example, the compound composing the adhesive may be a resin containing a copper atom, a resin containing a copper compound or a phosphate compound, a resin containing a copper compound or thio derivatives, or a resin containing a tungsten-based compound.

A coloring agent (dye or pigment) may be used to block near infrared waves. An example of the pigment is a cyanide based compound.

The conductive layer 5 may also be disposed on top of the base film 3, in addition to the configuration illustrated in FIG. 1, without departing from the scope of the present embodiments, as long as the electromagnetic and near infrared waves are blocked.

The anti-glare layer 1 is formed on the base film 3. Anti-glare refers to the scattering of external light incident on a surface of a film and the prevention of reflection of surroundings on the surface of the film.

Although not shown, the anti-glare layer 1 may be formed on the base film 3 with microprotrusions. The protrusions protrude in a direction opposite to where the base film 3 is disposed, and may be shaped in any form as long as the anti-glare layer 1 has an uneven surface so that diffused reflection can occur due to the sizes or pitches between the protrusions.

Recently, there has been increasing demand for plasma displays with wide viewing angles, quick response, and fine pitch, that is, high resolution. The fine pitch is achieved by micro-pixels. However, as the sizes of the pixels decreases, for example, for a fine pitch of 133 ppi (133 pixels/inch), the light reaching the viewer's eyes is deviated, and thus the viewer's eyes are strained due to the blinking light. Such a phenomenon occurs when light emitted from a single pixel is focused due to a lens effect caused by protrusions larger than pixels, which displays an image on the surface of the base film 3, or when RGB light emitted from adjacent cells is mixed. Therefore, it is preferable that the micro-protrusions on the anti-glare layer 1 be smaller than the pixels.

The anti-glare layer 1 may be formed using a deep coating method, an air knifing method, a curtain coating method, a roller coating method, a wire bar coating method, or a gravure coating method.

A hard coating is usually formed on the outermost surface of a film filter. When a plasma display apparatus, a monitor for a television or a computer, or a portable digital device is used, they receive various external forces. Thus, a hard coating prevents scratching of the film filter. A hard coating material (not shown) may be included in the anti-glare layer 1 (as in FIG. 1). Alternatively, the hard coating material 2 (in FIG. 2) may be formed on the anti-glare layer 1.

The hard coating material 2 may be an acryl-based polymer, urethane-based polymer, epoxy-based polymer, or siloxane-based polymer, and may also be an ultraviolet (UV) curable resin, such as an oligomer. To increase the hardness of the hard coating material 2, a silica-based filler can be further included.

The hard coating material formed on the anti-glare layer 1 has a haze of from about 3 to about 11% and a visible light transmittance of from about 30 to about 80%, and has a thickness of from about 2 to about 7 μm and a hardness of from about 2 to about 3H.

The hard coating material 2 is illustrated on top of the anti-glare layer 1 in FIGS. 1 and 2. However, the hard coating material 2 may be formed below the anti-glare layer 1. In addition, the hard coating material 2 may be included in the anti-glare layer 1. In this case, the hard coating material 2 illustrated in FIGS. 1 and 2 will be removed therefrom.

The MRT film filter 10 includes the adhesive 6 to fix the base film 3 composing the hard coating material 2, the anti-glare layer 1, and the conductive layer 5 to the MRT film 8. The adhesive 6 directly laminates the base film 3 and the MRT film 8. Thus, the adhesive 6 is an interface between the base film 3 and the MRT film 8. By using a base film 3 commonly used in the art and an MRT film 8 of average roughness, the base film 3 and the MRT film 8 may be adhered without using a separate material.

The adhesive 6 may include a thermoplastic, a UV curable resin, or a thermoplastic-UV curable compound resin. An example of the thermoplastic-UV curable compound resin is an acrylate-based resin. The adhesive 6 may be a pressure sensitive adhesive (PSA).

The adhesive 6 may be formed using a screen printing method, a deep coating method, an air knifing method, a curtain coating method, a roller coating method, a wire bar coating method, or a gravure coating method.

A coloring agent such as a dye or a pigment may be used for color correction or blocking neon light. The coloring pigment may be any material which can selectively absorb visible light having a wavelength of from about 400 to about 700 nm.

In particular, light having a wavelength of about 585 nm needs to be blocked due to the excitement of neon. To this end, the adhesive 6 may be made of a cyanine-based compound, squarylium-based compound, azomethine-based compound, xanthene-based compound, oxonol-based compound, azo-based compound, etc.

The MRT film 8 is disposed below the base film 3. A black coating 12 for improving contrast is formed on a top surface of the MRT film 8, and a lens unit 14 for focusing visible light is formed on a bottom surface of the MRT film 8.

The supporter 9 may be further disposed on the bottom surface of the MRT film 8. The supporter 9 may be adhered and fixed to a front surface of a flat display apparatus, which will be described later, without using a separate material.

The MRT film 8 is made of a compound selected from the group consisting of PES, PAR, PEI, PEN, PET, PPS, polyallylate, polyimide, PC, TAC, and CAP, and may preferably be PC, PET, TAC, or PEN.

The supporter 9 is formed on the bottom surface of the MRT film 8 and is fixed to the flat display apparatus. The supporter 9 directly laminates the MRT film 8 and the flat display apparatus. The supporter 9 may be a part of the flat display apparatus without using a separate material commonly used for adhering and fixing an element in the art and by an average roughness of the flat display apparatus. Also, the supporter 9 may be made of an adhesive material such as PSA. The MRT film 8 is fixed to the flat display apparatus via the supporter 9.

Also, the supporter 9 may include a film on which an adhesive such as PSA is deposited on both surfaces. Here, the film may be any one of the various films described above, and may be composed of PC, PET, TAC, or PEN. The MRT film 8 is fixed to the flat display apparatus via the supporter 9.

The black coating 12 is formed on top of the MRT film 8.

The black coating 12 improves the true contrast of visible light focused by the lens unit 14, which will be described later, and reduces external reflection. The black coating 12 may be shaped in numerous ways as long as it improves true contrast and reduces external light reflection, and may particularly be shaped in a striped pattern.

The black coating 12 may be formed using various methods, for example, using a typical depositing method such as a screen printing method, a deep coating method, an air knifing method, a curtain coating method, a roller coating method, a wire bar coating method, or a gravure coating method.

In addition to the methods described above, the black coating 12 may be formed using a CVD method or a PVD method, and preferably, a vapor deposition method or a sputtering method.

The black coating 12 may be composed of any material having a dark color as long as the black coating 12 improves true contrast and reduces external reflection.

The lens unit 14 is formed on the bottom surface of the MRT film 8. The lens unit 14 focuses visible light emitted from the flat display apparatus. The lens unit 14 protrudes toward the flat display apparatus and is realized by a plurality of protrusions.

Generally, a lens focuses visible light by utilizing the difference in the refraction indices of a medium through which the visible light passes and the lens (i.e., a convex lens) disperses the visible light (i.e., a concave lens). The principle of focusing the visible light is used in the present embodiment. The visible light which passed through the supporter 9 is refracted due to the difference in the refraction indices experienced while entering and exiting the lens unit 14.

According to Snell's Law regarding refraction index, the refractive index of the supporter 9 may be equal to or greater than that of the lens unit 14.

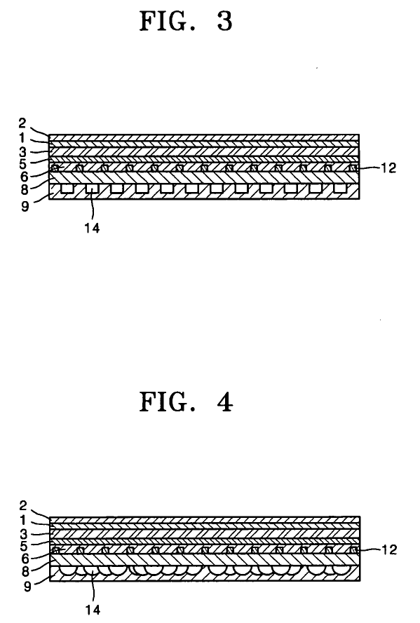

The lens unit 14 formed as protrusions is not limited to a particular shape, and may be formed as embossings or stripes, as illustrated in FIGS. 2 and 3. If the lens unit 14 is formed as embossings, the embossings may protrude toward the flat display apparatus on the bottom surface of the MRT film 8, as illustrated in FIG. 2. The protrusions are not limited to being round. In addition to being oval-shaped and circular as illustrated in FIG. 2, the protrusions may have a plurality of corners.

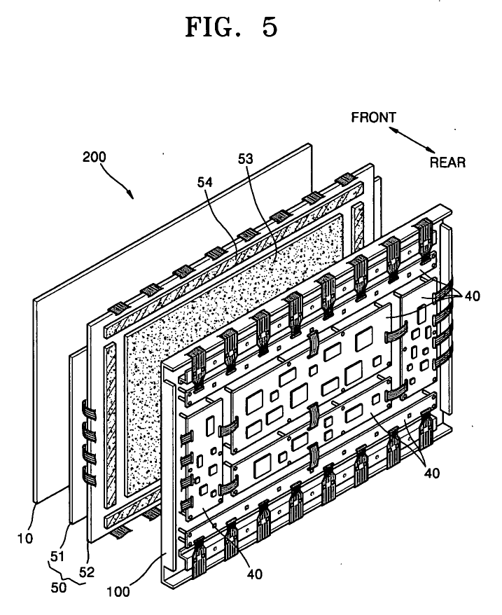

The sizes of the embossings or the pitches between the embossings need not be limited to focus visible light. In other words, when the lens unit 14 is formed on the bottom surface of the MRT film 8, as illustrated in FIG. 4, the semi-circular embossings may protrude towards the flat display apparatus 200 (see FIG. 5). In this case, the shapes of the embossings are not limited to semi-circles or ovals and may be polygons. In addition, the sizes of the embossings and the pitches between the embossings need not be limited to focus visible light.

FIG. 3 is a cross-sectional view of an MRT film filter according to another embodiment. The descriptions regarding a hard coating material 2, an anti-glare layer 1, a base film 3, a conductive layer 5, an adhesive 6, an MRT film 8, a supporter 9, and a black coating 12 in FIG. 3 will be omitted since they are the same as those described in the previous embodiment.

Referring to FIGS. 3 and 4, a lens unit 14 is formed on the bottom surface of the MRT film 8 and includes a plurality of protrusions protruding towards a flat display apparatus 200 (see FIG. 5). Although the protrusions are shaped as squares in FIG. 3, the protrusions are not limited to such a shape. For example, the protrusions may be semi-circles, ovals, or polygons, as long as they can focus visible light.

The size of the stripes and the pitches between the stripes need not be limited to focus visible light.

The refractive indices of the supporter 9 and the lens unit 14 are different so that visible light passing through the supporter 9 can be effectively focused via the lens unit 14. That is, the refractive index of the supporter 9 may be equal to or greater than that of the lens unit 14. By having such a structure, the visible light which passes through the supporter 9 can be more effectively focused when incident to the lens unit 14.

FIG. 5 is a perspective view of a plasma display apparatus 200 having an MRT film filter according to one embodiment. Referring to FIG. 5, the plasma display apparatus includes an MRT film filter 10, a front substrate 51, and a rear substrate 52. The description of the MRT film filter 10 will be omitted since it is substantially the same as that of the MRT film filter 10 in the previous embodiment, except that the supporter 9 (see FIG. 2) faces the front substrate 51 when adhering the MRT film filter 10 to the front of the plasma display apparatus 200.

The visible transmittance of the MRT film filter 10 may be from about 30 to about 80%.

The plasma display apparatus 200 includes a plasma display panel (PDP) 50, a chassis base 100, and driving circuit substrates 40.

The PDP 50 is composed of the front substrate 51 and the rear substrate 52, which are coupled to each other. A plurality of cells defined by barrier ribs are formed between the front and rear substrates 51 and 52. Red, green, and blue phosphor materials are deposited on sidewalls of the barrier ribs etc. defining the cells.

Gas such as neon gas is injected into the cells. A plurality of electrodes (not shown) are formed inside the front and rear substrate 51 and 52. A voltage is applied to the electrodes to cause gas discharge.

The PDP 50 displays an image by exciting the phosphor with UV rays. The UV rays are generated when the gas is excited during a glow discharge is excited by applying a voltage between the electrodes.

The chassis base 100 is adhered to the rear of the PDP 50. The chassis base 100 may have a hardness to support the PDP 50. Also, the chassis base 100 receives heat generated by the PDP 50 and transmits the heat to the outside.

Therefore, the chassis base 100 may be made of, for example, aluminium. The chassis base 100 is adhered to the PDP 50 via an adhesive part 54, such as a double-sided tape.

A heat transfer sheet 53 is disposed between the PDP 50 and the chassis base 100 where the adhesive 54 is not formed so that the heat generated by the PDP 50 is easily transmitted and dissipated. An adhesive part 54 may be formed of, for example, a double-sided tape.

The driving circuit boards 40 for driving the PDP 50 are disposed on the rear of the chassis base 100.

The present embodiments can also be adopted in other flat display apparatuses besides the plasma display apparatus without departing from the scope of the present embodiments.

The plasma display apparatus of the present embodiments has all the functions of a strengthened glass filter, which has a complex structure, in a thin film. Therefore, the plasma display apparatus is lighter and can be manufactured at a lower cost than a conventional filter.

In addition, by including an MRT film filter, interface characteristics of the conventional filter are improved, thereby preventing dual images. Also, the directionality of the PDP is improved by preventing diffused reflection, thereby reducing surface reflection and increasing true contrast.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. An MRT film filter comprising:
a base film;
an anti-glare layer disposed on one side of the base film;
a conductive layer disposed on one side of the base film and configured to block electromagnetic waves;
an MRT film disposed on one side of the base film configured to be adhered to a flat display apparatus; and
an adhesive disposed between the base film and the MRT film.

2. The MRT film filter of claim 1, wherein the base film is transparent.

3. The MRT film filter of claim 1, wherein visible transmittance of the MRT film filter is from about 30% to about 80%.

4. The MRT film filter of claim 1, wherein the base film is selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, policarbonate (PC), polyallylate, polyimide and cellulose acetate propionate (CAP).

5. The MRT film filter of claim 1, wherein the anti-glare layer contains a hard coating material.

6. The MRT film filter of claim 1, wherein the anti-glare layer is formed on the base film with microprotrusions.

7. The MRT film filter of claim 1, further comprising a hard coating material deposited on top of the anti-glare layer.

8. The MRT film filter of claim 7, wherein the hard coating is an acryl-based polymer, urethane-based polymer, epoxy-based polymer, a siloxane-based polymer or a ultraviolet curable resin.

9. The MRT film filter of claim 7, further comprising a silica-based filler included in the hard coating material.

10. The MRT film filter of claim 5, wherein the anti-glare layer contains the hard coating material, and has a thickness of from about 2 to about 7 μm, a hardness of from about 2 to about 3H, and a haze of from about 3 to about 11%.

11. The MRT film filter of claim 1, wherein the conductive layer is made of at least one of ITO, Ag, Au, Cu, and Al.

12. The MRT film filter of claim 1, wherein the adhesive contains a pigment or a dye for color correction or blocking neon light.

13. The MRT film filter of claim 1, wherein the adhesive comprises at least one of a cyanine-based compound, a squarylium-based compound, an azomethine-based compound, a xanthene-based compound, an oxonol-based compound and an azo-based compound.

14. The MRT film filter of claim 1, further comprising a supporter on the bottom surface of the MRT film to fix the MRT film to the flat display apparatus.

15. The MRT film filter of claim 1, further comprising:
a black coating on top of the MRT film to improve true contrast; and
a lens unit below the MRT film to focus visible light.

16. The MRT film filter of claim 15, wherein the lens unit comprises protrusions protruding in an opposite direction from where the MRT film is disposed.

17. The MRT film filter of claim 16, wherein the lens unit is formed as embossings.

18. The MRT film filter of claim 16, wherein the lens unit is formed as stripes.

19. The MRT film filter of claim 15, further comprising a supporter formed on the bottom surface of the MRT film to be fixed to the flat display apparatus,
wherein the refractive index of the lens unit is different from the refractive index of the supporter.

20. A plasma display apparatus comprising:
a plurality of electrodes;
a plasma display panel including a front substrate on which an image is displayed by visible light emitted by a discharge generated between the electrodes; and
an MRT film filter adhered to the front surface of the front substrate,
wherein the MRT film filter includes:
a base film;
an anti-glare layer disposed on one side of the base film;
a conductive layer disposed on one side of the base film and configured to block electromagnetic waves;
an MRT film disposed on on side of the base film to be adhered to the plasma display apparatus; and
an adhesive adapted to fix the MRT film to the base film.

21. The plasma display apparatus of claim 20, wherein the base film is selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, policarbonate (PC), polyallylate, polyimide and cellulose acetate propionate (CAP).

22. The plasma display apparatus of claim 20, wherein the anti-glare layer contains a hard coating material, and has a thickness of from about 2 to about 7 μm, a hardness of from about 2 to about 3H, and a haze of from about 3 to about 11%.

23. The plasma display apparatus of claim 20, further comprising a hard coating material is deposited on top of the anti-glare layer.

24. The plasma display apparatus of claim 20, wherein the conductive layer is made of at least one of ITO, Ag, Au, Cu, and Al.

25. The plasma display apparatus of claim 20, wherein the adhesive comprises a pigment or a dye for color correction or blocking neon light.

26. The plasma display apparatus of claim 20, wherein the adhesive comprises at least one of a cyanine-based compound, a squarylium-based compound, an azomethine-based compound, a xant hene-based compound, an oxonol-based compound and an azo-based compound.

27. The plasma display apparatus of claim 20, further comprising:
a black coating on top of the MRT film to improve true contrast; and
a lens unit below the MRT film to focus visible light.

28. The plasma display apparatus of claim 27, wherein the lens unit is formed of protrusions protruding in an opposite direction from where the MRT film is disposed.

29. The plasma display apparatus of claim 27, further comprising a supporter formed on the bottom surface of the MRT film to be fixed to the flat display apparatus,
wherein the refractive index of the lens unit is different from the refractive index of the supporter.
